(19) United States
(12) Patent Application Publication
(10) Pub. No.: US 2025/0308750 A1
(43) Pub. Date: Oct. 2, 2025

(54) COIL COMPONENT

(71) Applicant: TDK Corporation, Tokyo (JP)

(72) Inventors: Toshinori MATSUURA, Tokyo (JP); Kazuya Tobita, Tokyo (JP); Shinnosuke Suzuki, Tokyo (JP); Munehiro Takaku, Tokyo (JP); Hajime Kato, Tokyo (JP)

(73) Assignee: TDK Corporation, Tokyo (JP)

(21) Appl. No.: 19/085,387

(22) Filed: Mar. 20, 2025

(30) Foreign Application Priority Data
Mar. 29, 2024 (JP) 2024-056781

(51) Int. Cl. H01F 27/28; H01F 27/29; H01F 27/32

(52) U.S. Cl. CPC H01F 27/2804; H01F 27/292; H01F 27/323

(57) ABSTRACT

A first conductor layer includes a plurality of first conductors disposed in a direction in which a pair of side surfaces oppose each other. The plurality of first conductors each include a first conductor portion, a second conductor portion, and a third conductor portion connecting the first conductor portion and the second conductor portion. In each of the plurality of first conductors, positions of the first conductor portion and the second conductor portion in the direction are different from each other, and the third conductor portion extends in a direction different from directions in which the first conductor portion and the second conductor portion extend. In two first conductors adjacent to each other, a minimum distance between the third conductor portions is larger than a minimum distance between the first conductor portions and a minimum distance between the second conductor portions.

### CROSS-REFERENCE TO RELATED APPLICATIONS

This application is based upon and claims the benefit of priority from Japanese Patent Application No. 2024-056781, filed on Mar. 29, 2024, the entire contents of which are incorporated herein by reference.

### BACKGROUND

### Field

The present disclosure relates to a coil component.

### Description of the Related Art

Known coil components include an element body and a coil disposed in the element body (for example, refer to Japanese Unexamined Patent Publication No. 2015-141945). The element body includes, for example, a first main surface and a second main surface opposing each other, a first side surface and a second side surface opposing each other, and a third side surface and a fourth side surface opposing each other. The coil includes a first conductor layer positioned to oppose the first main surface and a second conductor layer positioned to oppose the second main surface. The first conductor layer includes a plurality of first conductors disposed in a direction in which the third side surface and the fourth side surface oppose each other. The second conductor layer includes a conductor connected to a corresponding first conductor of the plurality of first conductors.

### SUMMARY

One aspect of the present disclosure provides a coil component that can reduce occurrence of an electrical short circuit in a coil.

A coil component according to one aspect of the present disclosure includes: an element body including a first main surface and a second main surface opposing each other, a first side surface and a second side surface opposing each other, and a third side surface and a fourth side surface opposing each other; and a coil disposed in the element body. The coil includes: a first conductor layer positioned to oppose the first main surface; and a second conductor layer positioned to oppose the second main surface. The first conductor layer includes a plurality of first conductors disposed in a direction in which the third side surface and the fourth side surface oppose each other. Each of the plurality of first conductors including a first conductor portion positioned closer to the first side surface, a second conductor portion positioned closer to the second side surface and corresponding to the first conductor portion, and a third conductor portion connecting the first conductor portion and the second conductor portion. The second conductor layer includes a conductor including an end connected to the first conductor portion included in a corresponding first conductor of the plurality of first conductors, and an end connected to the second conductor portion included in the first conductor adjacent to the corresponding first conductor. In each of the plurality of first conductors, positions of the first conductor portion and the second conductor portion in the direction are different from each other, and the third conductor portion extends in a direction different from directions in which the first conductor portion and the second conductor portion extend. In two first conductors adjacent to each other, of the plurality of first conductors, a minimum distance between the third conductor portions is larger than a minimum distance between the first conductor portions and a minimum distance between the second conductor portions.

In the one aspect described above, in each of the plurality of first conductors, the positions of the first conductor portion and the second conductor portion in the direction in which the third side surface and the fourth side surface oppose each other are different from each other, and the third conductor portion extends in the direction different from the directions in which the first conductor portion and the second conductor portion extend.

A configuration in which a distance between the first conductors is large tends not to cause an electrical short circuit in the coil, as compared with a configuration in which the distance between the first conductors is small. A configuration in which the third conductor portion extends in the direction different from the directions in which the first conductor portion and the second conductor portion extend can easily adjust a distance between the third conductor portions. For example, a configuration in which the distance between the third conductor portions is larger than the distance between the first conductor portions can partially increase the distance between the first conductors, as compared with a configuration in which the distance between the third conductor portions is the same as the distance between the first conductor portions. For example, a configuration in which the distance between the third conductor portions is larger than the distance between the second conductor portions can partially increase the distance between the first conductors, as compared with a configuration in which the distance between the third conductor portions is the same as the distance between the second conductor portions.

In the configuration in which the minimum distance between the third conductor portions is larger than the minimum distance between the first conductor portions and the minimum distance between the second conductor portions, the distance between the third conductor portions is larger than the distance between the first conductor portions and larger than the distance between the second conductor portions. Therefore, the one aspect can reduce occurrence of the electrical short circuit in the coil.

In the one aspect described above, the plurality of first conductors may include a pair of first conductors and at least one first conductor positioned between the pair of first conductors. The at least one first conductor may have a width smaller than a width of each of the pair of first conductors.

A configuration in which the at least one first conductor has the width smaller than the width of each of the pair of first conductors can increase the distance between the first conductors. Therefore, this configuration can further reduce the occurrence of the electrical short circuit in the coil.

In the one aspect described above, the conductor included in the second conductor layer may include: a fourth conductor including an end connected to the first conductor portion included in the at least one first conductor; and a fifth conductor including an end connected to the second conductor portion included in the at least one first conductor. The coil may include: a first connection conductor connecting the first conductor portion included in the at least one first conductor and the fourth conductor; and a second connection conductor connecting the second conductor portion included in the at least one first conductor and the fifth conductor. The first conductor portion and the first connection conductor may each include an end region of a same area, the end regions of the first conductor portion and the first connection conductor being connected to each other. The second conductor portion and the second connection conductor may each include an end region of a same area, the end regions of the second conductor portion and the second connection conductor being connected to each other.

A configuration in which the coil includes the end regions can reliably connect the first conductor layer and the second conductor layer via the end regions.

In the one aspect described above, in the at least one first conductor, the third conductor portion may have a width larger than a width of each of the first conductor portion and the second conductor portion.

Inductance of the coil component is dependent upon the width of the first conductor. A configuration in which the third conductor portion has the width larger than the width of each of the first conductor portion and the second conductor portion can adjust the inductance of the coil component.

In the one aspect described above, each of the plurality of first conductors may have a same width throughout an entirety of each of the plurality of first conductors.

In the one aspect described above, an angle between the first conductor portion and the third conductor portion and an angle between the second conductor portion and the third conductor portion may be less than 180 degrees.

In the one aspect described above, the angle between the first conductor portion and the third conductor portion and the angle between the second conductor portion and the third conductor portion may be 90 degrees.

The one aspect described above may include an external electrode connected to the coil and disposed on the first main surface.

### BRIEF DESCRIPTION OF THE DRAWINGS

FIG. 1 is a perspective view illustrating a coil component according to an example;

FIG. 2 is a view illustrating a configuration of a conductor layer;

FIG. 3 is a view illustrating a configuration of a conductor layer;

FIG. 4 is a view illustrating a configuration of the conductor layers and a connection conductor;

FIG. 5 is a view illustrating a configuration of the conductor layers and a connection conductor;

FIG. 6 is a view illustrating a cross-sectional configuration of the coil component according to the example;

FIG. 7 is a view illustrating a configuration of a conductor layer;

FIG. 8 is a view illustrating a configuration of a conductor layer;

FIG. 9 is a view illustrating a configuration of a conductor layer;

FIG. 10 is a view illustrating a configuration of a conductor layer;

FIG. 11 is a perspective view illustrating a coil component according to a fifth modified example of the example;

FIG. 12 is a view illustrating a configuration of a conductor layer;

FIG. 13 is a view illustrating a configuration of a conductor layer;

FIG. 14 is a view illustrating a configuration of the conductor layers and a connection conductor;

FIG. 15 is a view illustrating a configuration of the conductor layers and a connection conductor;

FIG. 16 is a view illustrating a cross-sectional configuration of the coil component according to the fifth modified example;

FIG. 17 is a perspective view illustrating a coil component according to a sixth modified example of the example;

FIG. 18 is a view illustrating a configuration of a conductor layer;

FIG. 19 is a view illustrating a configuration of the conductor layers and a connection conductor;

FIG. 20 is a view illustrating a configuration of the conductor layers and a connection conductor; and

FIG. 21 is a view illustrating a cross-sectional configuration of the coil component according to the sixth modified example.

### DETAILED DESCRIPTION

In the following description, with reference to the drawings, the same reference numbers are assigned to the same components or to similar components having the same function, and overlapping description is omitted.

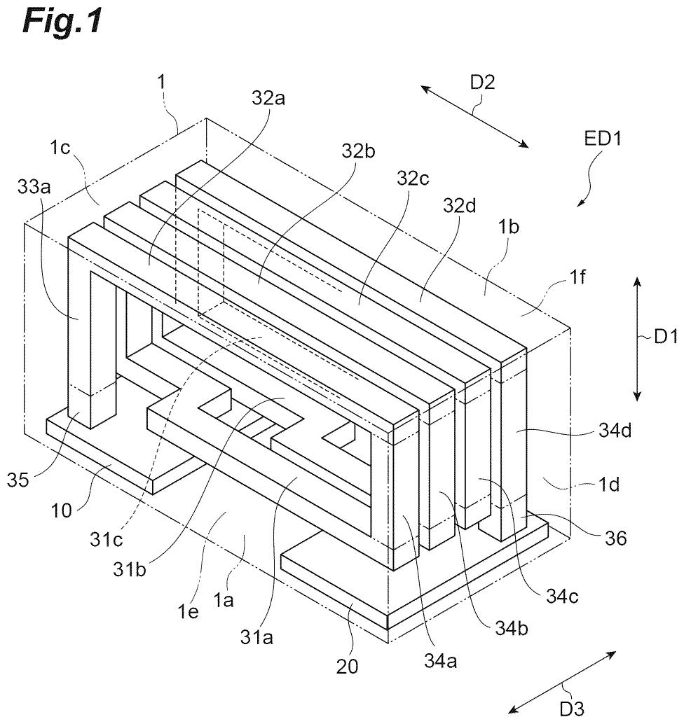

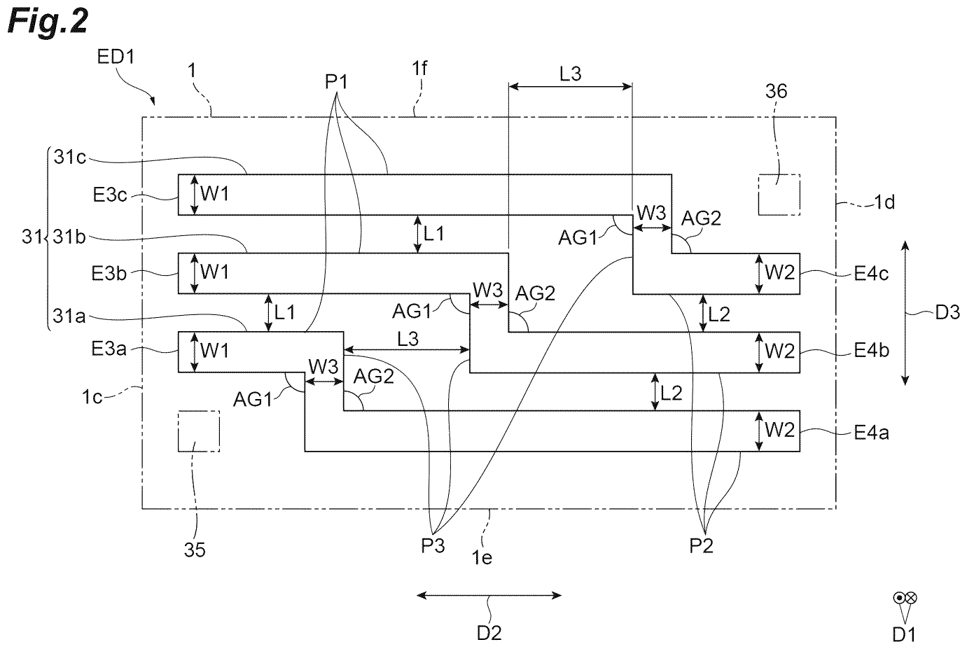

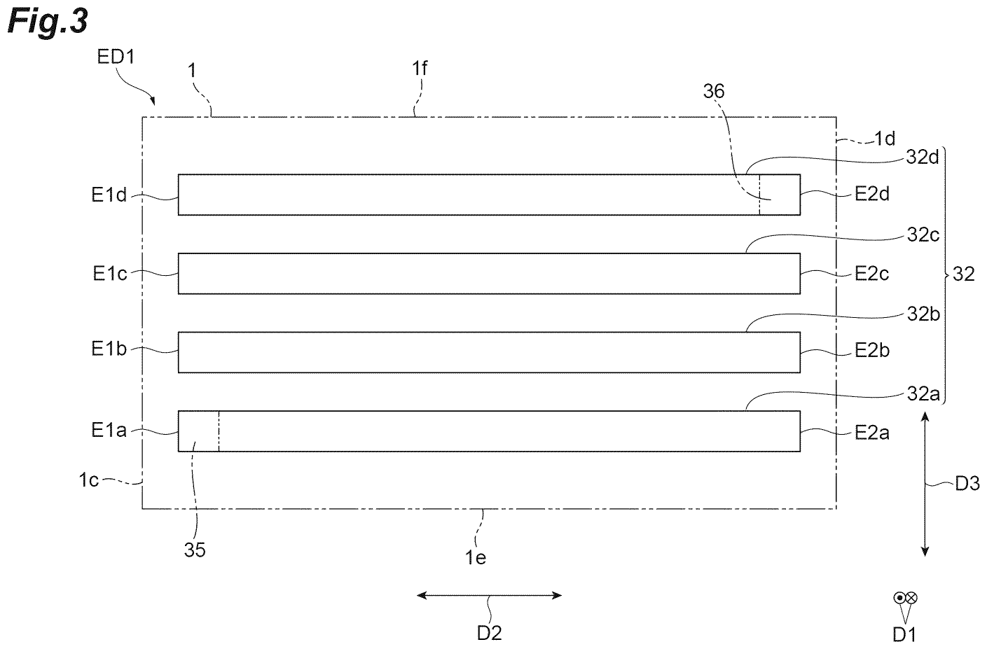

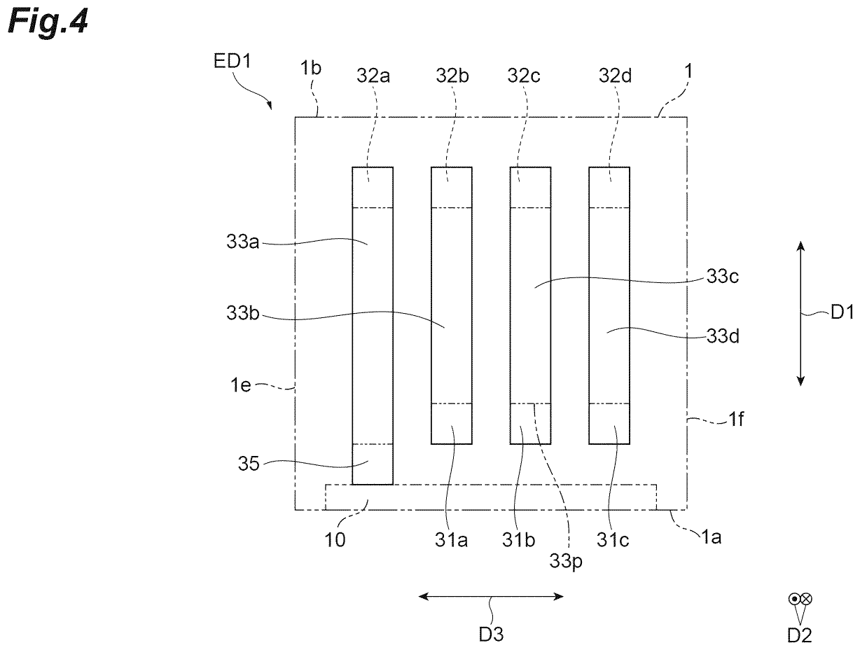

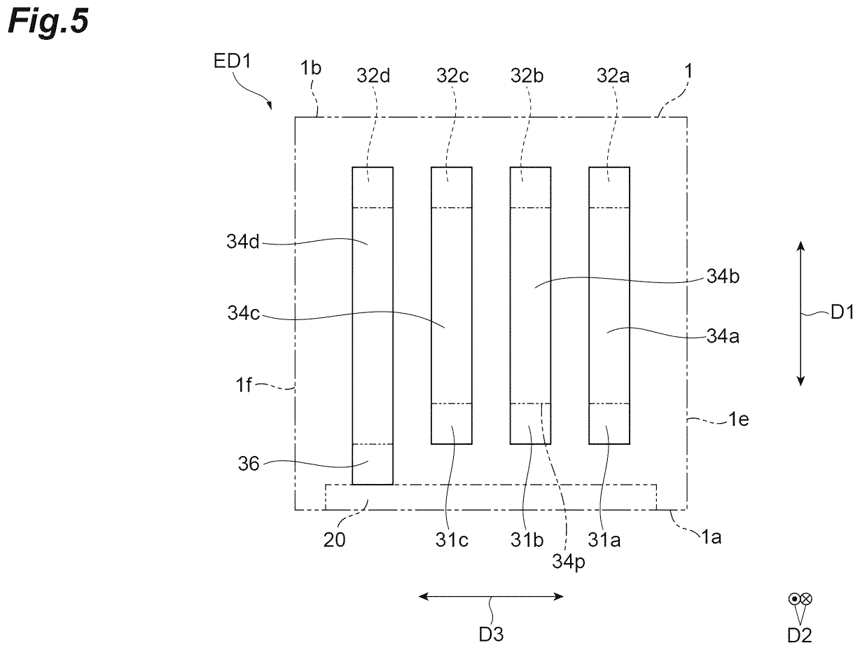

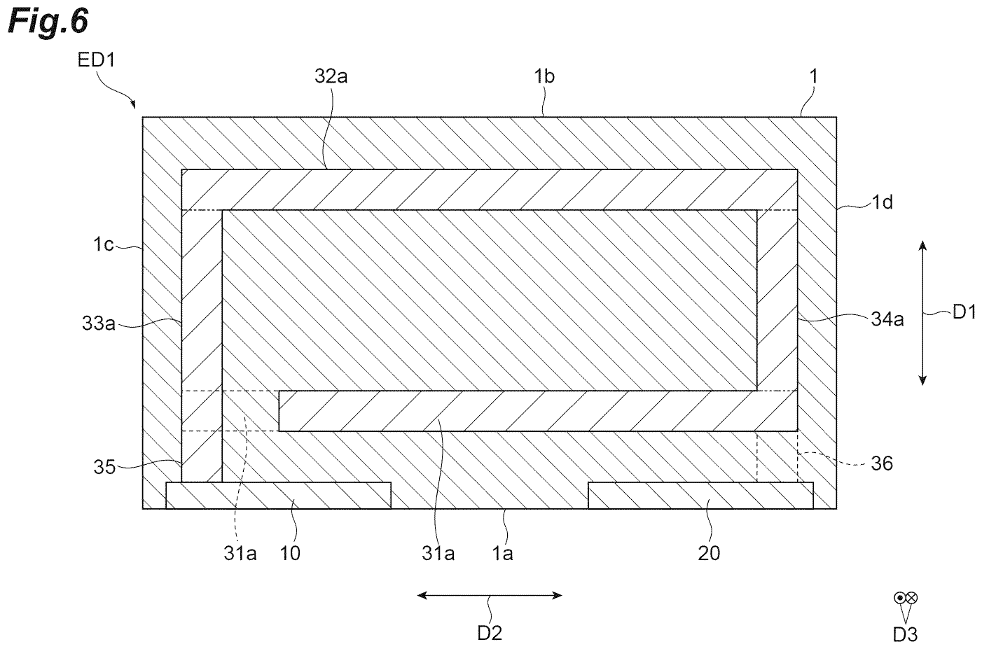

A configuration of a coil component EDI according to an example will be described with reference to FIGS. 1 to 6. FIG. 1 is a perspective view illustrating a coil component according to the example. FIG. 2 is a view illustrating a configuration of a conductor layer. FIG. 3 is a view illustrating a configuration of a conductor layer. FIGS. 4 and 5 are views illustrating a configuration of the conductor layers and a connection conductor. FIG. 6 is a view illustrating a cross-sectional configuration of the coil component according to the example.

As illustrated in FIGS. 1 to 6, the coil component EDI includes an element body 1, a plurality of external electrodes 10 and 20, a coil 30, a connection conductor 35, and a connection conductor 36. The plurality of external electrodes 10 and 20 are disposed on the element body 1. The coil 30 is disposed in the element body 1 and is electrically connected to the plurality of external electrodes 10 and 20. The connection conductor 35 electrically connects one end of the coil 30 and the external electrode 10. The connection conductor 36 electrically connects an other end of the coil 30 and the external electrode 20.

The element body 1 has a rectangular parallelepiped shape. The rectangular parallelepiped shape includes a rectangular parallelepiped shape in which corners and ridges are chamfered, or a rectangular parallelepiped shape in which the corners and ridges are rounded. The element body 1 includes a main surface 1a and a main surface 1b opposing each other, a side surface 1c and a side surface 1d opposing each other, and a side surface 1e and a side surface 1f opposing each other. The side surface 1c, the side surface 1d, the side surface 1e, and the side surface 1f couple the main surface 1a and the main surface 1b. An outer surface of the element body 1 includes, for example, the main surfaces 1a and 1b and four side surfaces 1c, 1d, 1e, and 1f.

For example, when the main surface 1a includes a first main surface, the main surface 1b includes a second main surface. For example, when the side surface 1c includes a first side surface, the side surface 1d includes a second side surface. For example, when the side surface 1e includes a third side surface, the side surface 1f includes a fourth side surface.

The main surfaces 1a and 1b oppose each other in a first direction D1. The main surface 1a is perpendicular to the first direction D1. The side surfaces 1c and 1d oppose each other in a second direction D2. The side surfaces 1e and 1f oppose each other in a third direction D3. The four side surfaces 1c, 1d, 1e, and 1f extend in the first direction D1 to couple the pair of main surfaces 1a and 1b. The side surfaces 1c and 1e are adjacent to each other. The side surfaces 1d and 1f are adjacent to each other.

A length of the element body 1 in the first direction D1 is, for example, 0.1 to 1 mm. A length of the element body 1 in the second direction D2 is, for example, 0.1 to 2 mm. A length of the element body 1 in the third direction D3 is, for example, 0.1 to 1 mm. In the element body 1, for example, the second direction D2 is a longitudinal direction.

The second direction D2 intersects with the first direction D1. The third direction D3 intersects with the first direction D1 and intersects with the second direction D2. For example, the first direction D1, the second direction D2, and the third direction D3 are perpendicular to each other.

For example, the main surface 1a is arranged to constitute a mounting surface. The main surface 1a includes the mounting surface. The main surface 1a opposes an electronic device when mounted on the electronic device. The electronic device includes, for example, a circuit board or an electronic component. Each of the main surfaces 1a and 1b and the four side surfaces 1c, 1d, 1e, and 1f has, for example, a rectangular shape. The rectangular shape includes a rectangular shape in which corners are chamfered or a rectangular shape in which corners are rounded.

The element body 1 includes, for example, a plurality of insulator layers having electrical insulation. For example, the element body 1 includes a plurality of insulator layers laminated in the first direction D1. The plurality of insulator layers are integrated to such an extent that boundaries between the insulator layers cannot be visually recognized. Each of the plurality of insulator layers has, for example, a rectangular shape when viewed from the first direction D1.

Each insulator layer includes, for example, a sintered green sheet including a magnetic material. The magnetic material includes, for example, a ferrite material. The ferrite material includes, for example, a Ni—Cu—Zn based ferrite material, a Ni—Cu—Zn—Mg based ferrite material, or a Ni—Cu based ferrite material. Each insulator layer may include an Fe alloy. Each insulator layer may include a non-magnetic material. The non-magnetic material includes, for example, a glass ceramic material or a dielectric material.

Each insulator layer may include a resin material. The resin material includes, for example, at least one selected from a group including a liquid crystal polymer, a polyimide resin, a crystalline polystyrene, an epoxy-based resin, an acrylic-based resin, a bismaleimide-based resin, and a fluorine-based resin. The resin material includes, for example, a filler. The filler includes, for example, an inorganic filler. The inorganic filler includes, for example, a silica. The resin material may include no filler.

The external electrodes 10 and 20 are disposed on the main surface 1a. For example, the external electrodes 10 and 20 are joined to terminals of the electronic device when mounting the coil component ED1. The external electrodes 10 and 20 are separated from each other in the second direction D2 and are electrically connected to the coil 30. The external electrode 10 is positioned closer to the side surface 1c than the external electrode 20, and the external electrode 20 is positioned closer to the side surface 1d than the external electrode 10. When viewed from the first direction D1, the external electrodes 10 and 20 are separated from four ends of the element body 1. Each of the four ends of the element body 1 overlaps with a corresponding side surface of the four side surfaces 1c, 1d, 1e, and 1f, when viewed from the first direction D1. The external electrodes 10 and 20 have, for example, a rectangular parallelepiped shape. The external electrodes 10 and 20 may be disposed on the main surface 1b. In this case, the main surface 1b includes, for example, the mounting surface.

The external electrodes 10 and 20 have, for example, a plate shape. The external electrodes 10 and 20 have a rectangular shape when viewed from the first direction D1. The external electrodes 10 and 20, for example, have the same dimensions as each other. For example, a portion of each of the external electrodes 10 and 20 is disposed in the element body 1, and an other portion of each of the external electrodes 10 and 20 is exposed from the main surface 1a.

In this specification, “same” does not necessarily mean only that values are identical. Even in the case in which a slight difference in a predetermined range, a manufacturing error, or a measurement error is included, it can be defined that values are the same to each other. For example, in the case in which each of values falls within a range of ±10% of an average value of the values, the values are defined to be the same to each other.

The external electrodes 10 and 20 include an electrically conductive material. The electrically conductive material includes, for example, Ag, Pd, Cu, or Al. The electrically conductive material includes, for example, an Ag—Pd alloy, an Ag—Cu alloy, an Ag—Au alloy, or an Ag—Pt alloy. The external electrodes 10 and 20 include, for example, a Ni plating film, a Sn plating film, a Cu plating film, or an Au plating film. The external electrodes 10 and 20 may have a multilayer structure of these plating films, and may include the Ni plating film and the Sn plating film on the Ni plating film. The plating film is formed through, for example, an electrolytic plating process or an electroless plating process. The thicknesses of the external electrodes 10 and 20 in the first direction D1 is, for example, 1 to 10 μm.

The coil 30 includes a conductor layer 31, a conductor layer 32, a connection conductor 33, and a connection conductor 34. The conductor layer 31 and the conductor layer 32 are connected to each other to form the coil 30 having a winding shape. The conductor layer 31 and the conductor layer 32 are electrically connected to each other. For example, a coil axis of the coils 30 is along the third direction D3. The conductor layer 31 is positioned to oppose the main surface 1a. The conductor layer 32 is positioned to oppose the main surface 1b. The conductor layer 31 is closer to the main surface 1a than the conductor layer 32. The conductor layer 32 is closer to the main surface 1b than the conductor layer 31. The connection conductor 33 and the connection conductor 34 connect the conductor layer 31 and the conductor layer 32. For example, when the conductor layer 31 includes a first conductor layer, the conductor layer 32 includes a second conductor layer.

The conductor layer 31 includes a plurality of conductors 31a, 31b, and 31c. The plurality of conductors 31a, 31b, and 31c are disposed in the third direction D3. The conductors 31a, 31b, and 31c are disposed substantially parallel to each other. The conductors 31a, 31b and 31c are disposed such that, for example, adjacent conductors of the plurality of conductors 31a, 31b, and 31c are substantially equidistant from each other. For example, the conductor layer 31 includes three conductors 31a, 31b, and 31c. The conductor 31a is closer to the side surface 1e than the conductors 31b and 31c. The conductor 31b is positioned between the conductor 31a and the conductor 31c. The conductor 31b is positioned to be interposed between two adjacent conductors 31a and 31c. The conductor 31c is closer to the side surface 1f than the conductors 31a and 31b. The conductors 31a, 31b, and 31c are disposed in the order of the conductor 31a, the conductor 31b, the conductor 31c. For example, each of the conductors 31a, 31b, and 31c includes a first conductor. That is, the conductor layer 31 includes the plurality of first conductors. The conductor layer 31 may include two first conductors and may include four or more first conductors. The conductor layer 31 includes, for example, the pair of conductors 31a and 31c and at least one conductor 31b positioned between the pair of conductors 31a and 31c.

The conductor 31a includes an end E3a. The end E3a is positioned closer to the side surface 1c. The conductor 31a includes an end E4a. The end E4a is positioned closer to the side surface 1d. The conductor 31b includes an end E3b. The end E3b is located closer to the side surface 1c. The conductor 31b includes an end E4b. The end E4b is positioned closer to the side surface 1d. The conductor 31c includes an end E3c. The end E3c is positioned closer to the side surface 1c. The conductor 31c includes an end E4c. The end E4c is positioned closer to the side surface 1d.

Each of the plurality of conductors 31a, 31b, 31c includes a conductor portion P1, a conductor portion P2, and a conductor portion P3.

The conductor portions P1 are positioned closer to the side surface 1c. The conductor portions P2 are positioned closer to the side surface 1d. The conductor portions P1 are positioned closer to the side surface 1c than the conductor portions P2. The conductor portions P2 are positioned closer to the side surface 1d than the conductor portion P1. In each of the plurality of conductors 31a, 31b, 31c, the conductor portions P2 correspond to the conductor portions P1. The conductor portions P1 and P2 extend substantially in the second direction D2.

The conductor portion P1 included in the conductor 31a has a length in the second direction D2 that is smaller than a length in the second direction D2 of the conductor portion P2 included in the conductor 31a. The conductor portion P1 included in the conductor 31b has a length in the second direction D2 that is the same as a length in the second direction D2 of the conductor portion P2 included in the conductor 31b. The conductor portion P1 included in the conductor 31c has a length in the second direction D2 that is larger than a length in the second direction D2 of the conductor portion P2 included in the conductor 31c. The length in the second direction D2 of the conductor portion P1 included in the conductor 31b may not be the same as the length in the second direction D2 of the conductor portion P2 included in the conductor 31b. The length in the second direction D2 of the conductor portion P1 included in the conductor 31b may not be different from the length in the second direction D2 of the conductor portion P2 included in the conductor 31b. The length in the second direction D2 of the conductor portion P1 included in the conductor 31b is larger than the length in the second direction D2 of the conductor portion P1 included in the conductor 31a. The length in the second direction D2 of the conductor portion P1 included in the conductor 31c is larger than the length in the second direction D2 of the conductor portion P1 included in the conductor 31b.

The conductor portion P3 couples the conductor portion P1 and the conductor portion P2. The conductor portion P3 is positioned between the conductor portion P1 and the conductor portion P2 in the second direction D2. The conductor portion P3 extends in a direction different from directions in which the conductor portions P1 and P2 extend. For example, the conductor portion P3 extends substantially in the third direction D3. The conductor portion P3 may extend in a curved manner. In the conductors 31a, 31b, and 31c, an angle AG1 between the conductor portion P1 and the conductor portion P3 and an angle AG2 between the conductor portion P2 and the conductor portion P3 are, for example, approximately 90 degrees. The conductor portion P1 is continuous to the conductor portion P3. The conductor portion P3 is continuous to the conductor portion P2. The angle AG1 may be the same as or different from the angle AG2.

As illustrated in FIG. 2, the conductor portion P1, the conductor portion P2, and the conductor portion P3 have a rectangular shape when viewed from the first direction D1. The direction in which the conductor portion P1 extends may be gradually changed toward the third direction D3 in a region connected to the conductor portion P3. The direction in which the conductor portion P2 extends may be gradually changed toward the third direction D3 in a region connected to the conductor portion P3. The direction in which the conductor portion P3 extends may be gradually changed toward the second direction D2 in regions connected to the conductor portions P1 and P2. When viewed from the first direction D1, the conductor portion P1, the conductor portion P2, and the conductor portion P3 may not have a rectangular shape in the regions connected to each other.

For example, when the conductor portion P1 includes a first conductor portion, the conductor portion P2 includes a second conductor portion, and the conductor portion P3 includes a third conductor portion.

The conductor layer 32 includes a plurality of conductors 32a, 32b, 32c, and 32d. The plurality of conductors 32a, 32b, 32c, and 32d are disposed in the third direction D3. The conductors 32a, 32b, 32c, and 32d are disposed substantially parallel to each other. The conductors 32a, 32b, 32c, and 32d are disposed, for example, such that conductors adjacent to each other, of the conductors 32a, 32b, 32c, and 32d, are substantially equidistant from each other. For example, the conductor layer 32 includes four conductors 32a, 32b, 32c, and 32d. The conductor 32a is closer to the side surface 1e than the conductors 32b, 32c, and 32d. The conductors 32b and 32c are positioned between the conductor 32a and the conductor 32d. The conductor 32b is closer to the side surface 1e than the conductor 32c. The conductor 32d is closer to the side surface 1f than the conductors 32a, 32b, and 32c. The conductors 32a, 32b, 32c, and 32d are disposed in the order of the conductor 32a, the conductor 32b, the conductor 32c, and the conductor 32d. For example, the conductor 32c includes a fourth conductor, and the conductor 32b includes a fifth conductor.

A positional relationship among the conductor layers 31 and 32, the connection conductors 33 and 34, and the connection conductors 35 and 36 will be described below.

In each of the three conductors 31a, 31b, and 31c, positions of the conductor portion P1 and the conductor portion P2 in the third direction D3 are different from each other. In the conductor 31a, the positions of the conductor portion P1 and the conductor portion P2 in the third direction D3 are different from each other. For example, when viewed from the first direction D1, the conductor portion P1 included in the conductor 31a overlaps with the conductor 32b, and the conductor portion P2 included in the conductor 31a overlaps with the conductor 32a. In the conductor 31a, the amount of difference in position between the conductor portion P1 and the conductor portion P2 in the third direction D3 is the same as a distance between the conductor 32b and the conductor 32a in the third direction D3.

In the conductor 31b, the positions of the conductor portion P1 and the conductor portion P2 in the third direction D3 are different from each other. For example, when viewed from the first direction D1, the conductor portion P1 included in the conductor 31b overlaps with the conductor 32c, and the conductor portion P2 included in the conductor 31b overlaps with the conductor 32b. In the conductor 31b, the amount of difference in position between the conductor portion P1 and the conductor portion P2 in the third direction D3 is the same as a distance between the conductor 32c and the conductor 32b in the third direction D3.

In the conductor 31c, the positions of the conductor portion P1 and the conductor portion P2 in the third direction D3 are different from each other. For example, when viewed from the first direction D1, the conductor portion P1 included in the conductor 31c overlaps with the conductor 32d, and the conductor portion P2 included in the conductor 31c overlaps with the conductor 32c. In the conductor 31c, the amount of difference in position between the conductor portion P1 and the conductor portion P2 in the third direction D3 is the same as a distance between the conductor 32c and the conductor 32b in the third direction D3.

As illustrated in FIG. 4, the connection conductor 33 includes a plurality of conductors 33a, 33b, 33c, and 33d. The conductor 33a connects the connection conductor 35 and the conductor 32a. For example, the conductor 33a directly connects the connection conductor 35 and the conductor 32a. The conductor 33a is continuous with the connection conductor 35 and continuous with the conductor 32a. The conductor 33b connects the conductor 31a and the conductor 32b. For example, the conductor 33b directly connects the conductor 31a and the conductor 32b. The conductor 33b is continuous with the conductor 31a and continuous with the conductor 32b. The conductor 33c connects the conductor 31b and the conductor 32c. For example, the conductor 33c directly connects the conductor 31b and the conductor 32c. The conductor 33c is continuous with the conductor 31b and continuous with the conductor 32c. The conductor 33d connects the conductor 31c and the conductor 32d. For example, the conductor 33d directly connects the conductor 31c and the conductor 32d. The conductor 33d is continuous with the conductor 31c and continuous with the conductor 32d.

As illustrated in FIG. 5, the connection conductor 34 includes a plurality of conductors 34a, 34b, 34c, and 34d. The conductor 34a connects the conductor 31a and the conductor 32a. For example, the conductor 34a directly connects the conductor 31a and the conductor 32a. The conductor 34a is continuous with the conductor 31a and continuous with the conductor 32a. The conductor 34b connects the conductor 31b and the conductor 32b. For example, the conductor 34b directly connects the conductor 31b and the conductor 32b. The conductor 34b is continuous with the conductor 31b and continuous with the conductor 32b. The conductor 34c connects the conductor 31c and the conductor 32c. For example, the conductor 34c directly connects the conductor 31c and the conductor 32c. The conductor 34c is continuous with the conductor 31c and continuous with the conductor 32c. The conductor 34d connects the connection conductor 36 and the conductor 32d. For example, the conductor 34d directly connects the connection conductor 36 and the conductor 32d. The conductor 34d is continuous with the connection conductor 36 and continuous with the conductor 32d. For example, when the conductor 33c (connection conductor 33) includes a first connection conductor, the conductor 34b (connection conductor 34) includes a second connection conductor.

The conductor 32a includes an end E1a. The end E1a is positioned closer to the side surface 1c and is connected to the connection conductor 35. The end E1a is electrically connected to the connection conductor 35 via the conductor 33a. The conductor 32a includes an end E2a. The end E2a is positioned closer to the side surface 1d and is connected to the end E4a. The end E2a is electrically connected to the end E4a via the conductor 34a. When viewed from the first direction D1, the end E1a overlaps the connection conductor 35, and the end E2a overlaps the end E4a.

The conductor 32b includes an end E1b. The end E1b is positioned closer to the side surface 1c and is connected to the end E3a. The end E1b is electrically connected to the end E3a via the conductor 33b. The conductor 32b includes an end E2b. The end E2b is positioned closer to the side surface 1d and is connected to the end E4b. The end E2b is electrically connected to the end E4b via the conductor 34b. When viewed from the first direction D1, the end E1b overlaps the end E3a, and the end E2b overlaps the end E4b.

The conductor 32c includes an end E1c. The end E1c is positioned closer to the side surface 1c and is connected to the end E3b. The end E1c is electrically connected to the end E3b via the conductor 33c. The conductor 32c includes an end E2c. The end E2c is positioned closer to the side surface 1d and is connected to the end E4c. The end E2c is electrically connected to the end E4c via the conductor 34c. When viewed from the first direction D1, the end E1c overlaps the end E3b, and the end E2c overlaps the end E4c.

The conductor 32d includes an end E1d. The end E1d is positioned closer to the side surface 1c and is connected to the end E3c. The end E1d is electrically connected to the end E3c via the conductor 33d. The conductor 32d includes an end E2d. The end E2d is positioned closer to the side surface 1d and is connected to the connection conductor 36. The end E2d is electrically connected to the connection conductor 36 via the conductor 34d. When viewed from the first direction D1, the end E1d overlaps the end E3c, and the end E2d overlaps the connection conductor 36.

The connection conductor 35 connects an end of the conductor 33a and the external electrode 10. The connection conductor 35 is disposed in the element body 1 to be arranged with the conductors 31a, 31b, and 31c in the third direction D3. The connection conductor 35 is disposed closer to the side surface 1c and the side surface 1e. The connection conductor 36 connects an end of the conductor 34d and the external electrode 20. The connection conductor 36 is disposed in the element body 1 to be arranged with the conductors 31a, 31b, and 31c in the third direction D3. The connection conductor 36 is disposed closer to the side surface 1d and the side surface 1f.

When the conductors 31a to 31c and 32a to 32d are cut in a plane perpendicular to the directions in which the conductors 31a to 31c and 32a to 32d extend, the cross-sectional shapes of the conductors 31a to 31c and 32a to 32d include, for example, a substantially rectangular shape. When the conductors 33a to 33d and 34a to 34d are cut in a plane perpendicular to the directions in which the conductors 33a to 33d and 34a to 34d extend, the cross-sectional shapes of the conductors 33a to 33d and 34a to 34d include, for example, a substantially rectangular shape. When the connection conductors 35 and 36 are cut in a plane perpendicular to the directions in which the connection conductors 35 and 36 extend, the cross-sectional shapes of the connection conductors 35 and 36 include, for example, a substantially rectangular shape. The above-described cross-sectional shapes of the plurality of conductors 31a to 31c, 32a to 32d, 33a to 33d, and 34a to 34d and the connection conductors 35 and 36 may include, for example, a substantially circular shape, a substantially elliptical shape, or a substantially polygonal shape other than a rectangular shape.

The conductors 31a to 31c, 32a to 32d, 33a to 33d, 34a to 34d and the connection conductor 35 and 36 include an electrically conductive material. The electrically conductive material includes, for example, copper. The conductors 31a to 31c, 32a to 32d, 33a to 33d, and 34a to 34d and the connection conductor 35 and 36 are not exposed from the main surfaces 1a and 1b and the side surfaces 1c, 1d, 1e, and 1f.

A distance between the two adjacent conductors 31a and 31b includes a minimum distance L1 between the conductor portions P1. A distance between the two adjacent conductors 31b and 31c includes the minimum distance L1 between the conductor portions P1. The minimum distance L1 is a minimum distance between the conductor portions P1 in the third direction D3. The distance between the two adjacent conductors 31a and 31b includes a minimum distance L2 between the conductor portions P2. The distance between the two adjacent conductors 31b and 31c includes the minimum distance L2 between the conductor portions P2. The minimum distance L2 is a minimum distance between the conductor portions P2 in the third direction D3. The distance between the two adjacent conductors 31a and 31b includes a minimum distance L3 between the conductor portions P3. The distance between the two adjacent conductors 31b and 31c includes the minimum distance L3 between the conductor portions P3. The minimum distance L3 is a minimum distance between the conductor portions P3 in the second direction D2. The minimum distance L3 is larger than the minimum distance LI and the minimum distance L2.

The conductor 31a, for example, has a same width throughout its entire length. The conductor 31b, for example, has a same width throughout its entire length. The conductor 31c, for example, has a same width throughout its entire length. In this case, widths W1 of the conductor portions P1, widths W2 of the conductor portions P2, and widths W3 of the conductor portions P3, which are included in the conductors 31a, 31b, and 31c, are the same as each other. The width W1 of the conductor portion P1 is an outer diameter of the conductor portion P1 in a direction orthogonal to the direction in which the conductor portion P1 extends. The width W2 of the conductor portion P2 is an outer diameter of the conductor portion P2 in a direction orthogonal to the direction in which the conductor portion P2 extends. The width W3 of the conductor portion P3 is an outer diameter of the conductor portion P3 in a direction orthogonal to the direction in which the conductor portion P3 extends.

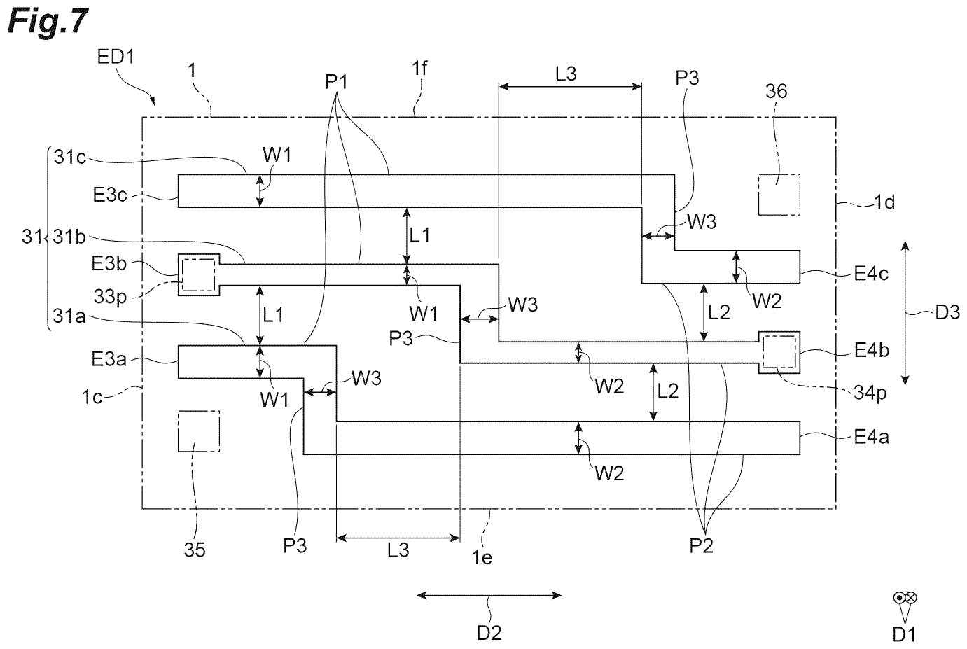

A configuration of a coil component ED1 according to a first modified example of the present example will be described with reference to FIG. 7. The coil component ED1 according to the first modified example is generally similar to or the same as the coil component ED1 according to the above-described example. However, the coil component ED1 according to the first modified example is different from the coil component ED1 according to the above-described example in a configuration of the conductor layer 31. Hereinafter, differences between the above-described example and the first modified example will be mainly described. The coil component ED1 according to the first modified example includes a conductor layer (not illustrated) having the same configuration as the conductor layer 32 included in the coil component ED1 according to the above-described example. The coil component ED1 according to the first modified example includes connection conductors (not illustrated) having the same configuration as the connection conductors 33 and 34 included in the coil component ED1 according to the above-described example.

FIG. 7 is a view illustrating a configuration of a conductor layer. In the first modified example, the coil component ED1 includes, for example, three conductors 31a, 31b, and 31c. The conductor 31b is positioned between the conductors 31a and 31c. The conductor 31b has a width smaller than a width of each of the conductors 31a and 31c. A width W1 of the conductor portion P1 included in the conductor 31b is smaller than a width W1 of the conductor portion P1 included in the conductor 31a and a width W1 of the conductor portion P1 included in the conductor 31c. A width W2 of the conductor portion P2 included in the conductor 31b is smaller than a width W2 of the conductor portion P2 included in the conductor 31a and a width W2 of the conductor portion P2 included in the conductor 31c. A width W3 of the conductor portion P3 included in the conductor 31b is smaller than a width W3 of the conductor portion P3 included in the conductor 31a and a width W3 of the conductor portion P3 included in the conductor 31c. The coil 30 may include four or more conductors. In this case, for example, the number of conductors positioned between the conductors 31a and 31c is two or more.

Each of the conductor portion P1 included in the conductor 31b and the conductor 33c includes an end region 33p. The end region 33p of the conductor portion P1 included in the conductor 31b and the end region 33p of the conductor 33c are connected to each other and have a same area. The conductor portion P1 included in the conductor 31b and the conductor 33c are electrically connected to each other via the end regions 33p. The conductor portion P1 included in the conductor 31b has a same area as that of the conductor 33c at the end region 33p.

Each of the conductor portion P2 included in the conductor 31b and the conductor 34b includes an end region 34p. The end region 34p of the conductor portion P2 included in the conductor 31b and the end region 34p of the conductor 34b are connected to each other and have a same area. The conductor portion P2 included in the conductor 31b and the conductor 34b are electrically connected to each other via the end regions 34p. The conductor portion P2 included in the conductor 31b has a same area as that of the conductor 34b at the end region 34p. FIG. 7 illustrates the end regions 33p and 34p viewed from the first direction D1.

The distance between the two adjacent conductors 31a and 31b includes a minimum distance L1 between the conductor portions P1 of the conductors 31a and 31b. The distance between the two adjacent conductors 31b and 31c includes the minimum distance L1 between the conductor portions P1 of the conductors 31b and 31c. The minimum distance L1 is a minimum distance between the conductor portions P1 in the third direction D3. The distance between the two adjacent conductors 31a and 31b includes a minimum distance L2 between the conductor portions P2 of the conductors 31a and 31b. The distance between the two adjacent conductors 31b and 31c includes the minimum distance L2 between the conductor portions P2 of the conductors 31b and 31c. The minimum distance L2 is a minimum distance between the conductor portions P2 in the third direction D3. The distance between the two adjacent conductors 31a and 31b includes a minimum distance L3 between the conductor portions P3 of the conductors 31a and 31b. The distance between the two adjacent conductors 31b and 31c includes the minimum distance L3 between the conductor portions P3 of the conductors 31b and 31c. The minimum distance L3 is a minimum distance between the conductor portions P3 in the second direction D2. The minimum distance L3 is larger than the minimum distance L1 and the minimum distance L2. The minimum distance L1 in the first modified example is larger than the minimum distance L1 in the above-described example. The minimum distance L2 in the first modified example is larger than the minimum distance L2 in the above-described example. The minimum distance L3 in the first modified example is larger than the minimum distance L3 in the above-described example.

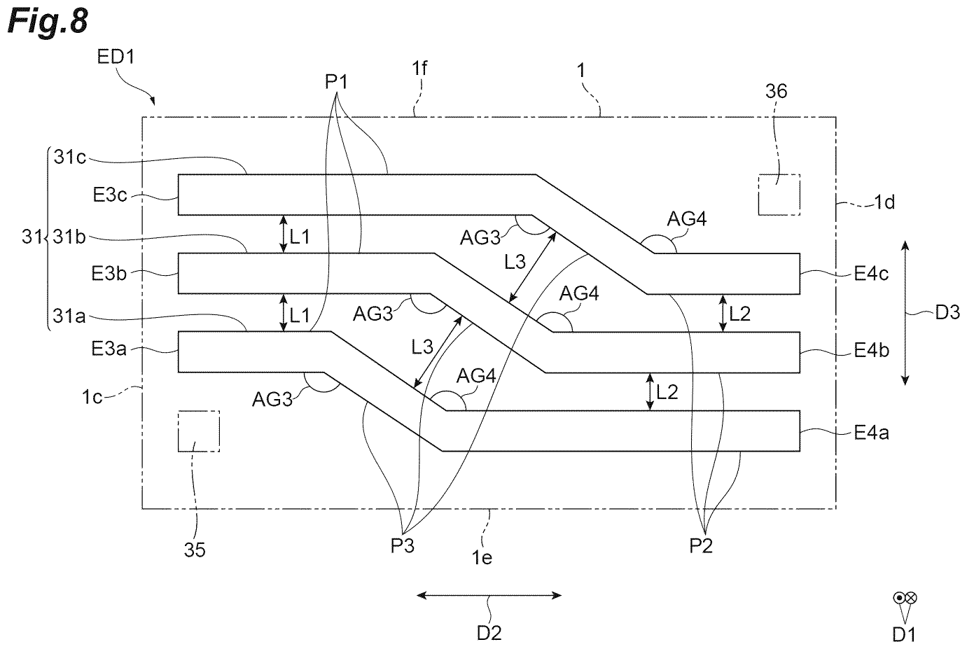

A configuration of a coil component ED1 according to a second modified example of the present example will be described with reference to FIG. 8. The coil component ED1 according to the second modified example is generally similar to or the same as the coil component ED1 according to the above-described example. However, the coil component ED1 according to the second modified example is different from the coil component ED1 according to the above-described example in a configuration of the conductor layer 31. Hereinafter, differences between the above-described example and the second modified example will be mainly described. The coil component ED1 according to the second modified example includes a conductor layer (not illustrated) having the same configuration as the conductor layer 32 included in the coil component ED1 according to the above-described example. The coil component ED1 according to the second modified example includes connection conductors (not illustrated) having the same configuration as the connection conductors 33 and 34 included in the coil component ED1 according to the above-described example.

In the second modified example, the conductor layer 31 includes three conductors 31a, 31b, and 31c. The three conductors 31a, 31b, and 31c are disposed in the third direction D3. The conductors 31a, 31b, and 31c are disposed substantially parallel to each other. The conductors 31a, 31b and 31c are disposed such that, for example, adjacent conductors of the plurality of conductors 31a, 31b, and 31c are substantially equidistant from each other.

Each of the three conductors 31a, 31b, and 31c includes the conductor portion P1, the conductor portion P2, and the conductor portion P3. The conductor portion P1 and the conductor portion P2 extend in the second direction D2. The conductor portion P3 connects the conductor portion P1 and the conductor portion P2. The conductor portion P3 is positioned between the conductor portion P1 and the conductor portion P2 in the second direction D2. The conductor portion P3 extends in a direction different from the directions in which the conductor portion P1 and the conductor portion P2 extend. In the conductors 31a, 31b, and 31c, an angle AG3 between the conductor portion P1 and the conductor portion P3 and an angle AG4 between the conductor portion P2 and the conductor portion P3 are, for example, less than 180 degrees. The angle AG3 and the angle AG4 are, for example, greater than 90 degrees and less than 180 degrees. The angles AG3 of the conductors 31a, 31b, and 31c are equal to each other. The angles AG4 of the conductors 31a, 31b, and 31c are equal to each other. The angle AG3 may be the same as the angle AG4, or may be different from the angle AG4.

The distance between the two adjacent conductors 31a and 31b includes the minimum distance L1 between the conductor portions P1. The distance between the two adjacent conductors 31b and 31c includes the minimum distance L1 between the conductor portions P1. The minimum distance L1 is a minimum distance between the conductor portions P1 in the third direction D3. The distance between the two adjacent conductors 31a and 31b includes a minimum distance L2 between the conductor portions P2. The distance between the two adjacent conductors 31b and 31c includes the minimum distance L2 between the conductor portions P2. The minimum distance L2 is a minimum distance between the conductor portions P2 in the third direction D3. The distance between the two adjacent conductors 31a and 31b includes a minimum distance L3 between the conductor portions P3. The distance between the two adjacent conductors 31b and 31c includes the minimum distance L3 between the conductor portions P3. The minimum distance L3 is a minimum distance between the conductor portions P3 in a direction intersecting the second direction D2 and the third direction D3. The minimum distance L3 is larger than the minimum distance L1 and the minimum distance L2.

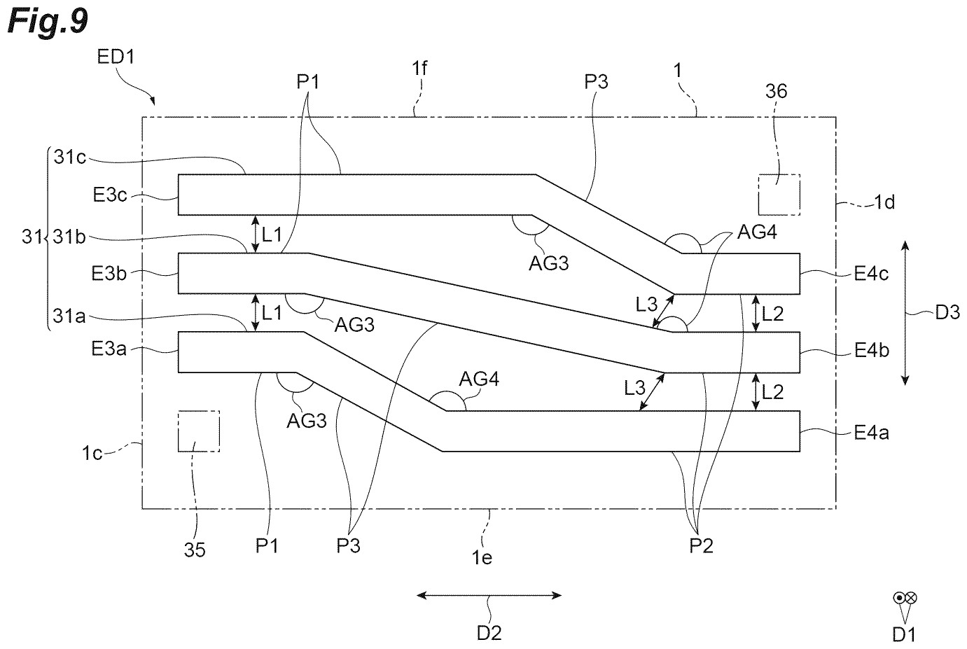

A configuration of a coil component ED1 according to a third modified example of the present example will be described with reference to FIG. 9. The coil component ED1 according to the third modified example is generally similar to or the same as the coil component ED1 according to the above-described example. However, the coil component ED1 according to the third modified example is different from the coil component ED1 according to the above-described example in a configuration of the conductor layer 31. Hereinafter, differences between the above-described example and the third modified example will be mainly described. The coil component ED1 according to the third modified example includes a conductor layer (not illustrated) having the same configuration as the conductor layer 32 included in the coil component ED1 according to the above-described example. The coil component ED1 according to the third modified example includes connection conductors (not illustrated) having the same configuration as the connection conductors 33 and 34 included in the coil component ED1 according to the above-described example.

The conductor portion P3 extends in a direction different from the directions in which the conductor portion P1 and the conductor portion P2 extend. An angle AG3 between the conductor portion P1 and the conductor portion P3 and an angle AG4 between the conductor portion P2 and the conductor portion P3 are, for example, less than 180 degrees. The angle between the conductor portions P1 and P2 is measured inside the conductor portions P1 and P2. The angle AG3 of the conductor 31b is larger than the angles AG3 of the conductor 31a and the conductor 31c. The angle AG4 of the conductor 31b is larger than the angles AG4 of the conductor 31a and the conductor 31c.

The distance between the two adjacent conductors 31a and 31b includes the minimum distance L1 between the conductor portions P1. The distance between the two adjacent conductors 31b and 31c includes the minimum distance L1 between the conductor portions P1. The minimum distance L1 is a minimum distance between the conductor portions P1 in the third direction D3. The distance between the two adjacent conductors 31a and 31b includes a minimum distance L2 between the conductor portions P2. The distance between the two adjacent conductors 31b and 31c includes the minimum distance L2 between the conductor portions P2. The minimum distance L2 is a minimum distance between the conductor portions P2 in the third direction D3. The distance between the two adjacent conductors 31a and 31b includes a minimum distance L3 between the conductor portions P3. The distance between the two adjacent conductors 31b and 31c includes the minimum distance L3 between the conductor portions P3. The minimum distance L3 is a minimum distance between the conductor portions P3 in a direction intersecting the second direction D2 and the third direction D3. The minimum distance L3 is larger than the minimum distance L1 and the minimum distance L2.

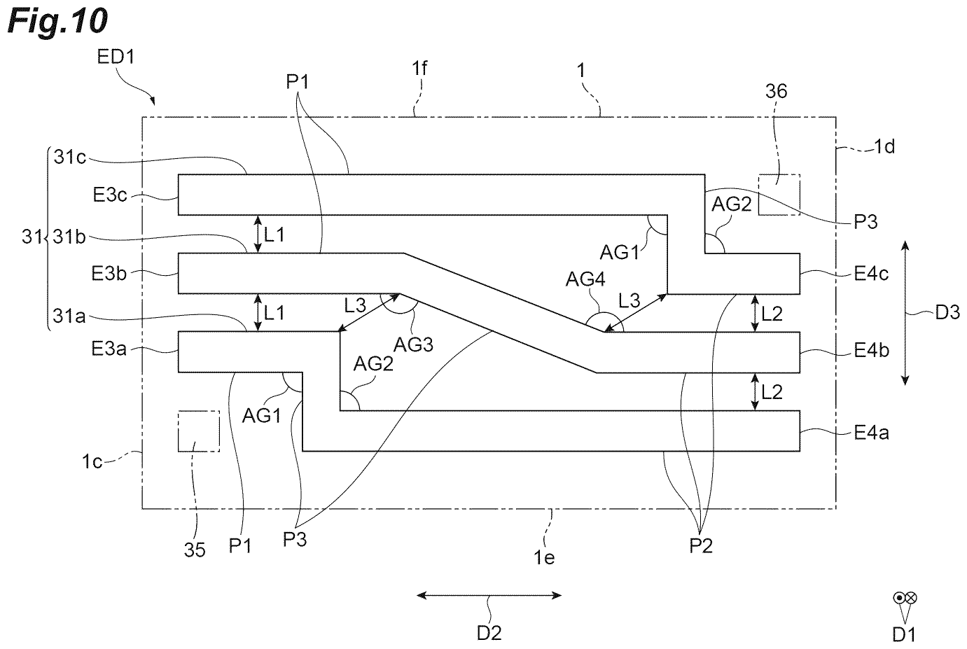

A configuration of a coil component ED1 according to a fourth modified example of the present example will be described with reference to FIG. 10. The coil component ED1 according to the fourth modified example is generally similar to or the same as the coil component ED1 according to the above-described example. However, the coil component ED1 according to the fourth modified example is different from the coil component ED1 according to the above-described example in a configuration of the conductor layer 31. Hereinafter, differences between the above-described example and the fourth modified example will be mainly described. The coil component ED1 according to the fourth modified example includes a conductor layer (not illustrated) having the same configuration as the conductor layer 32 included in the coil component ED1 according to the above-described example. The coil component ED1 according to the fourth modified example includes connection conductors (not illustrated) having the same configuration as the connection conductors 33 and 34 included in the coil component ED1 according to the above-described example.

The conductor portion P3 extends in a direction different from the directions in which the conductor portion P1 and the conductor portion P2 extend. In each of the conductor 31a and the conductor 31c, an angle AG3 between the conductor portion P1 and the conductor portion P3 and an angle AG4 between the conductor portion P2 and the conductor portion P3 are, for example, 90 degrees. The conductor portions P3 included in the conductor 31a and the conductor 31c extend in the third direction D3, for example. In the conductor 31b, an angle AG3 between the conductor portion P1 and the conductor portion P3 and an angle AG4 between the conductor portion P2 and the conductor portion P3 are, for example, less than 180 degrees. The angle AG3 of the conductor 31b is larger than the angles AG3 of the conductor 31a and the conductor 31c. The angle AG4 of the conductor 31b is larger than the angles AG4 of the conductor 31a and the conductor 31c.

The distance between the two adjacent conductors 31a and 31b includes the minimum distance L1 between the conductor portions P1. The distance between the two adjacent conductors 31b and 31c includes the minimum distance L1 between the conductor portions P1. The minimum distance L1 is a minimum distance between the conductor portions P1 in the third direction D3. The distance between the two adjacent conductors 31a and 31b includes a minimum distance L2 between the conductor portions P2. The distance between the two adjacent conductors 31b and 31c includes the minimum distance L2 between the conductor portions P2. The minimum distance L2 is a minimum distance between the conductor portions P2 in the third direction D3. The distance between the two adjacent conductors 31a and 31b includes a minimum distance L3 between the conductor portions P3. The distance between the two adjacent conductors 31b and 31c includes the minimum distance L3 between the conductor portions P3. The minimum distance L3 is a minimum distance between the conductor portions P3 in a direction intersecting the second direction D2 and the third direction D3. The minimum distance L3 is larger than the minimum distance L1 and the minimum distance L2.

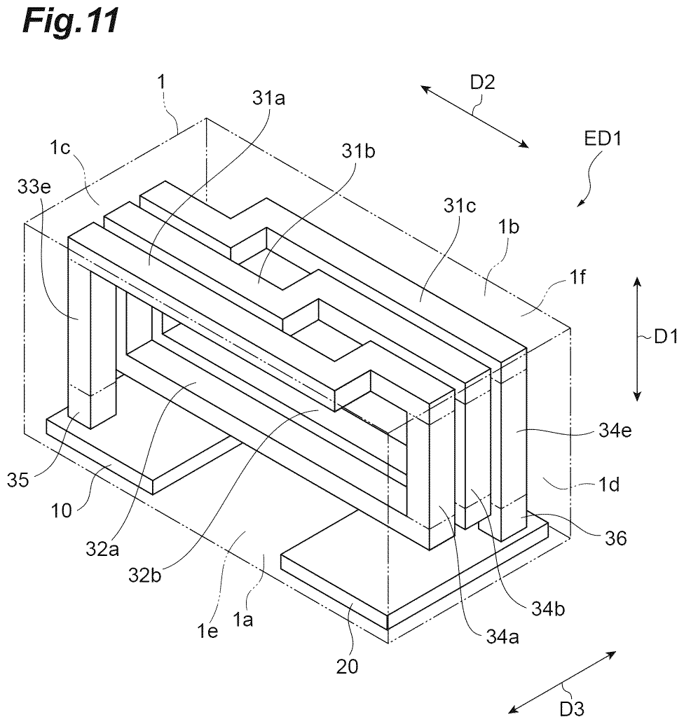

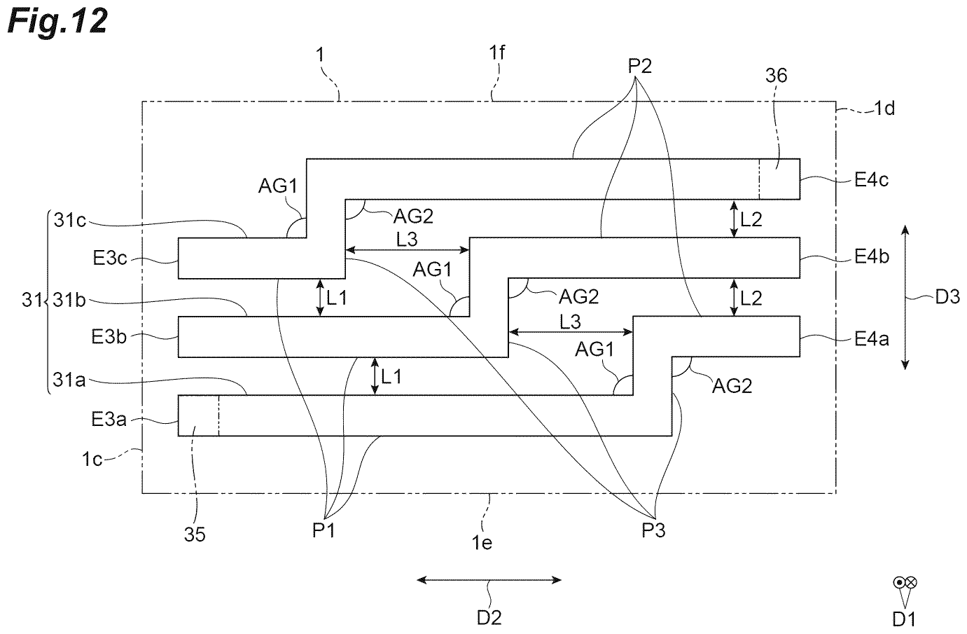

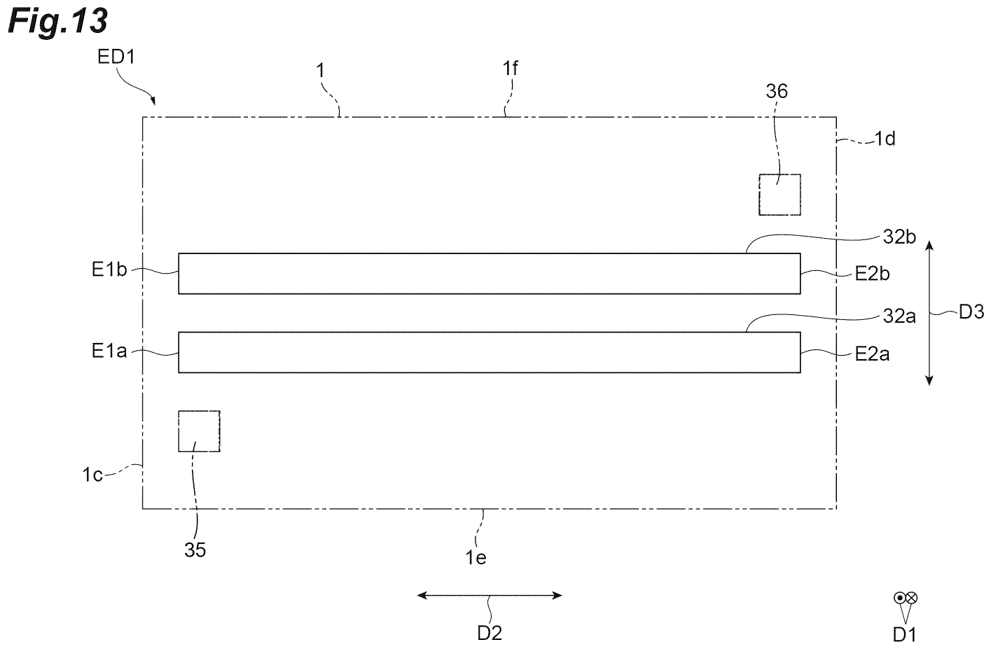

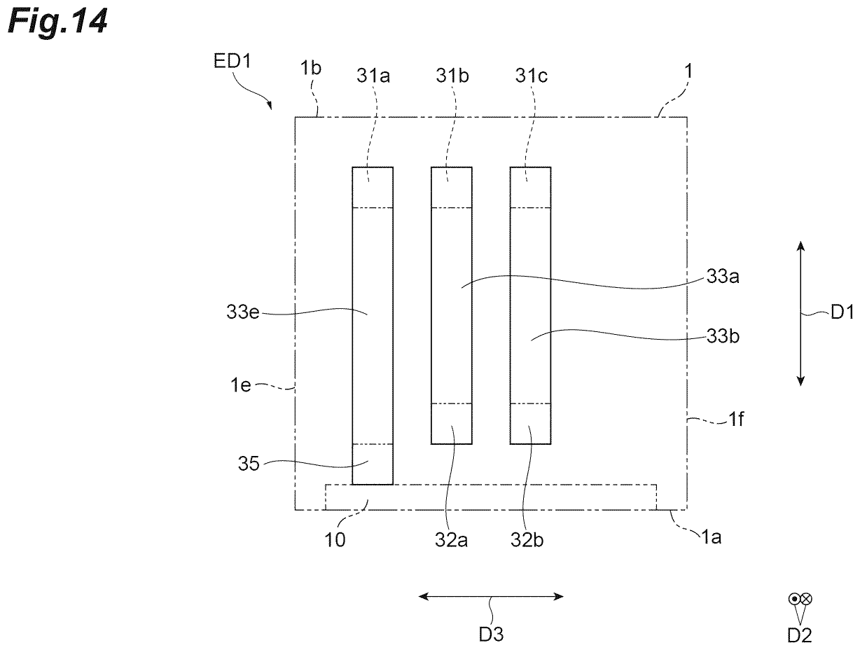

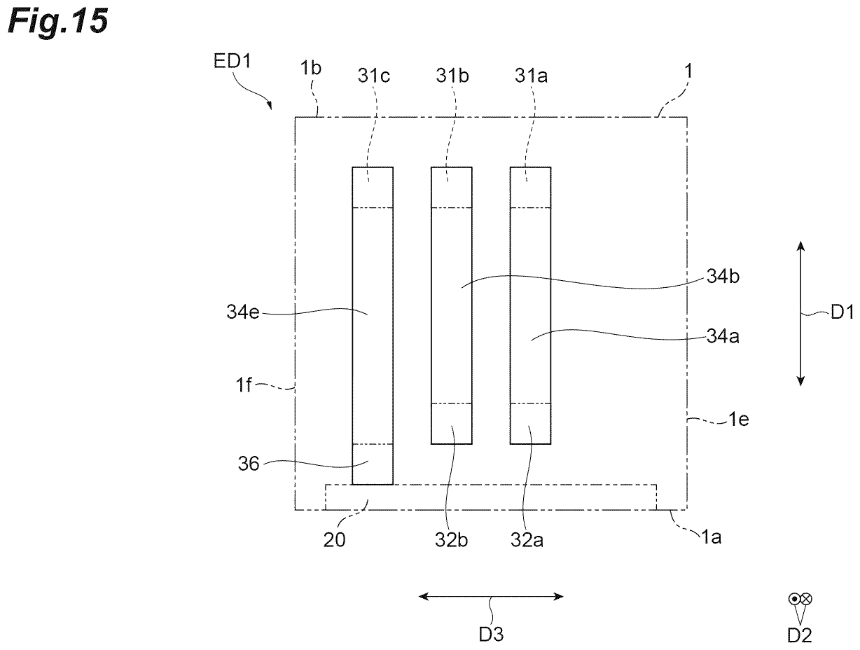

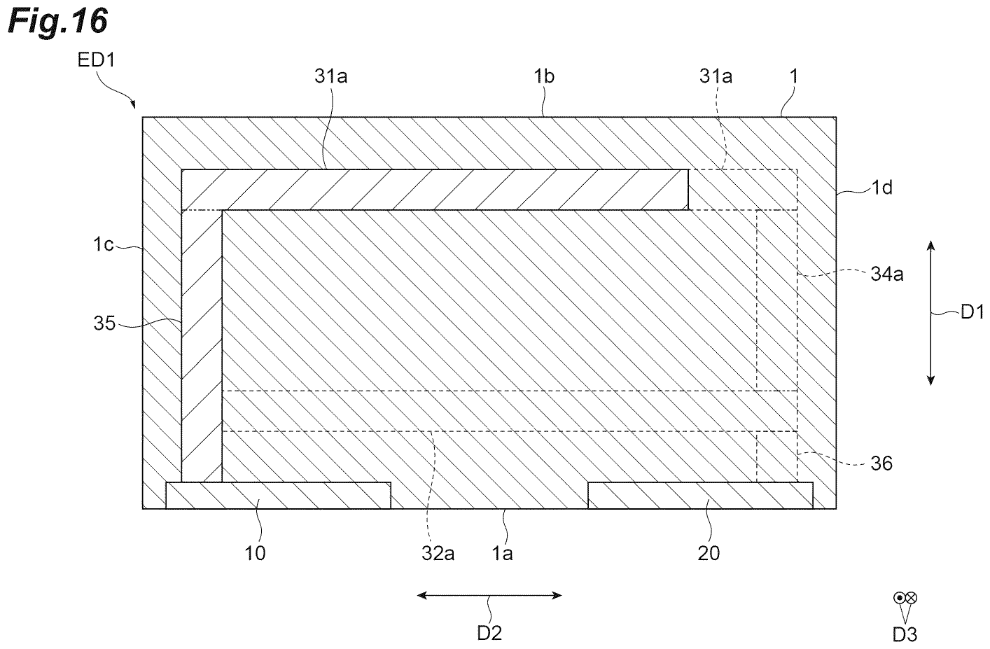

A configuration of a coil component ED1 according to a fifth modified example of the present example will be described with reference to FIGS. 11 to 16. FIG. 11 is a perspective view illustrating a coil component according to the fifth modified example. FIG. 12 is a view illustrating a configuration of a conductor layer. FIG. 13 is a view illustrating a configuration of a conductor layer. FIGS. 14 and 15 are views illustrating a configuration of the conductor layers and a connection conductor. FIG. 16 is a view illustrating a cross-sectional configuration of the coil component according to the fifth modified example. The coil component ED1 according to the fifth modified example is generally similar to or the same as the coil component ED1 according to the above-described example. However, the coil component ED1 according to the fifth modified example is different from the coil component ED1 according to the above-described example in a configuration of the coil 30. Hereinafter, differences between the above-described example and the fifth modified example will be mainly described.

In the fifth modified example, the coil 30 includes a conductor layer 31, a conductor layer 32, a connection conductor 33, and a connection conductor 34. The conductor layer 31 and the conductor layer 32 are connected to each other to form the coil 30 having a winding shape. In the fifth modified example, a coil axis of the coil 30 is along the third direction D3. The conductor layer 31 is positioned to oppose the main surface 1b. The conductor layer 32 is positioned to oppose the main surface 1a. The conductor layer 31 is closer to the main surface 1b than the conductor layer 32. The conductor layer 32 is closer to the main surface 1a than the conductor layer 31. The connection conductor 33 and the connection conductor 34 connect the conductor layer 31 and the conductor layer 32.

The conductor layer 31 includes, for example, three conductors 31a, 31b, and 31c. The conductors 31a, 31b and 31c are disposed in the third direction D3. The conductors 31a, 31b, and 31c are disposed substantially parallel to each other. The conductors 31a, 31b and 31c are disposed such that, for example, adjacent conductors of the conductors 31a, 31b, and 31c are substantially equidistant from each other. The conductor portions P1 are positioned closer to the side surface 1c. The conductor portions P2 are positioned closer to the side surface 1d. The conductor portions P1 and P2 extend in the second direction D2.

The conductor portion P1 included in the conductor 31a has a length in the second direction D2 that is larger than a length in the second direction D2 of the conductor portion P2 included in the conductor 31a. The conductor portion P1 included in the conductor 31b has a same length in the second direction D2 as a length in the second direction D2 of the conductor portion P2 included in the conductor 31b. The conductor portion P1 included in the conductor 31c has a length in the second direction D2 that is smaller than a length in the second direction D2 of the conductor portion P2 included in the conductor 31c. The length in the second direction D2 of the conductor portion P1 included in the conductor 31b may be different from the length in the second direction D2 of the conductor portion P2 included in the conductor 31b. The length in the second direction D2 of the conductor portion P1 included in the conductor 31b is smaller than the length in the second direction D2 of the conductor portion P1 included in the conductor 31a. The length in the second direction D2 of the conductor portion P1 included in the conductor 31c is smaller than the length in the second direction D2 of the conductor portion P1 included in the conductor 31b.

The conductor portion P3 couples the conductor portion P1 and the conductor portion P2. The conductor portion P3 is positioned between the conductor portion P1 and the conductor portion P2 in the second direction D2. The conductor portion P3 extends in a direction different from directions in which the conductor portions P1 and P2 extend. For example, the conductor portion P3 extends substantially in the third direction D3. In the conductors 31a, 31b, and 31c, an angle AG1 between the conductor portion P1 and the conductor portion P3 and an angle AG2 between the conductor portion P2 and the conductor portion P3 are, for example, approximately 90 degrees. The conductor portion P1 is continuous with the conductor portion P3. The conductor portion P3 is continuous with the conductor portion P2.

The conductor layer 32 includes, for example, two conductors 32a and 32b. The two conductors 32a and 32b are disposed in the third direction D3. The conductors 32a and 32b are disposed substantially parallel to each other. The conductor 32a is closer to the side surface 1e than the conductor 32b. The conductor 32b is closer to the side surface 1f than the conductor 32a.

In the conductor 31a, the positions of the conductor portion P1 and the conductor portion P2 in the third direction D3 are different from each other. The conductor portion P2 included in the conductor 31a overlaps with the conductor 32a. In the conductor 31b, the positions of the conductor portion P1 and the conductor portion P2 in the third direction D3 are different from each other. When viewed from the first direction D1, the conductor portion P1 included in the conductor 31b overlaps with the conductor 32a, and the conductor portion P2 included in the conductor 31b overlaps with the conductor 32b. In the conductor 31b, the amount of difference in position between the conductor portion P1 and the conductor portion P2 in the third direction D3 is the same as a distance between the conductor 32a and the conductor 32b in the third direction D3. In the conductor 31c, the positions of the conductor portion P1 and the conductor portion P2 in the third direction D3 are different from each other. When viewed from the first direction D1, the conductor portion P1 included in the conductor 31c overlaps with the conductor 32b.

A distance between the two adjacent conductors 31a and 31b includes a minimum distance L1 between the conductor portions P1. A distance between the two adjacent conductors 31b and 31c includes the minimum distance L1 between the conductor portions P1. The minimum distance L1 is a minimum distance between the conductor portions P1 in the third direction D3. The distance between the two adjacent conductors 31a and 31b includes a minimum distance L2 between the conductor portions P2. The distance between the two adjacent conductors 31b and 31c includes the minimum distance L2 between the conductor portions P2. The minimum distance L2 is a minimum distance between the conductor portions P2 in the third direction D3. The distance between the two adjacent conductors 31a and 31b includes a minimum distance L3 between the conductor portions P3. The distance between the two adjacent conductors 31b and 31c includes the minimum distance L3 between the conductor portions P3. The minimum distance L3 is a minimum distance between the conductor portions P3 in the second direction D2. The minimum distance L3 is larger than the minimum distance L1 and the minimum distance L2.

As illustrated in FIG. 14, the connection conductor 33 includes a plurality of conductors 33e, 33a, and 33b. The conductor 33e connects the connection conductor 35 and the conductor 31a. For example, the conductor 33e directly connects the connection conductor 35 and the conductor 31a. The conductor 33e is continuous with the connection conductor 35 and continuous with the conductor 31a. The conductor 33a connects the conductor 32a and the conductor 31b. For example, the conductor 33a directly connects the conductor 32a and the conductor 31b. The conductor 33a is continuous with the conductor 32a and continuous with the conductor 31b. The conductor 33b connects the conductor 32b and the conductor 31c. For example, the conductor 33b directly connects the conductor 32b and the conductor 31c. The conductor 33b is continuous with the conductor 32b and continuous with the conductor 31c.

As illustrated in FIG. 15, the connection conductor 34 includes a plurality of conductors 34a, 34b, and 34e. The conductor 34a connects the conductor 32a and the conductor 31a. For example, the conductor 34a directly connects the conductor 32a and the conductor 31a. The conductor 34a is continuous with the conductor 32a and continuous with the conductor 31a. The conductor 34b connects the conductor 32b and the conductor 31b. For example, the conductor 34b directly connects the conductor 32b and the conductor 31b. The conductor 34b is continuous with the conductor 32b and continuous with the conductor 31b. The conductor 34e connects the connection conductor 36 and the conductor 31c. For example, the conductor 34e directly connects the connection conductor 36 and the conductor 31c. The conductor 34e is continuous with the connection conductor 36 and continuous with the conductor 31c.

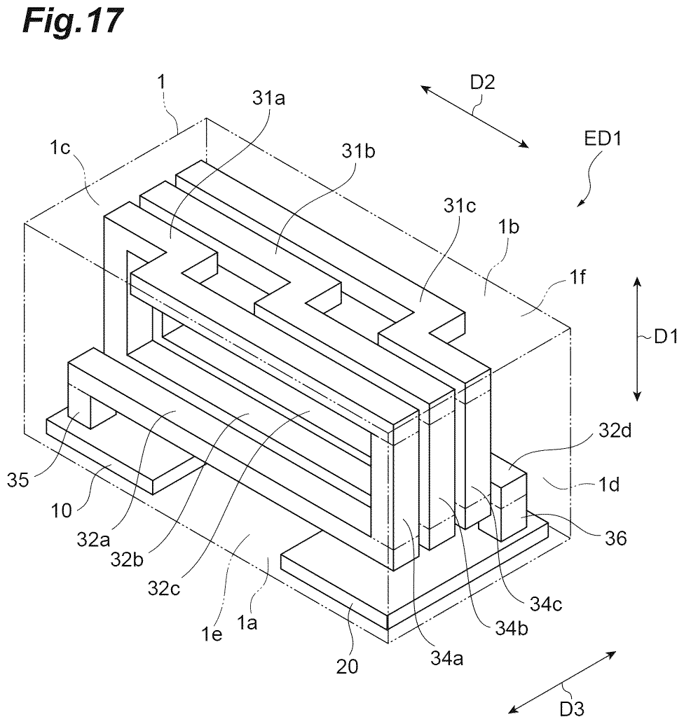

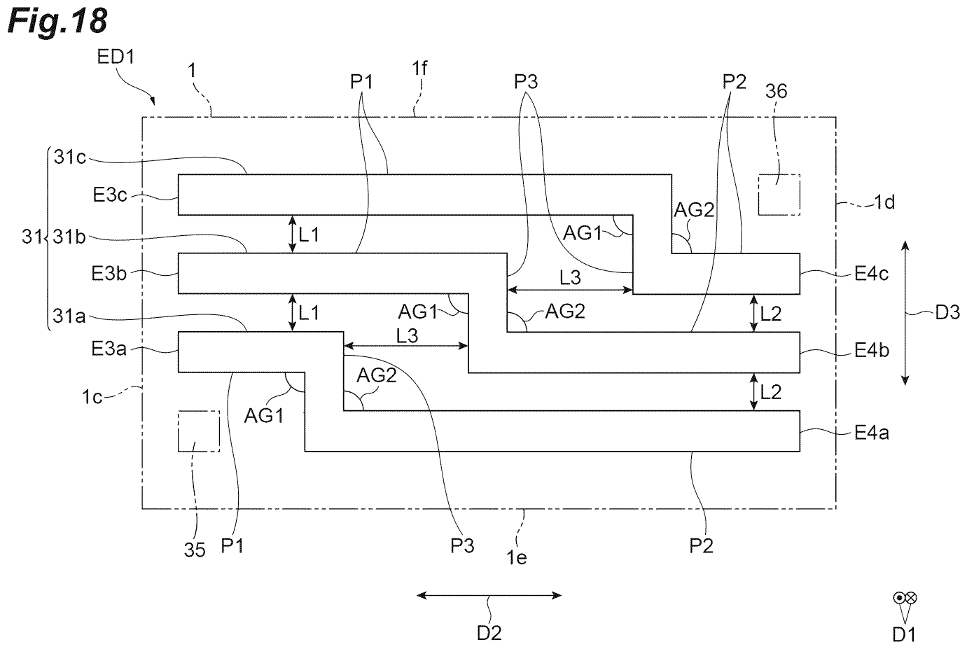

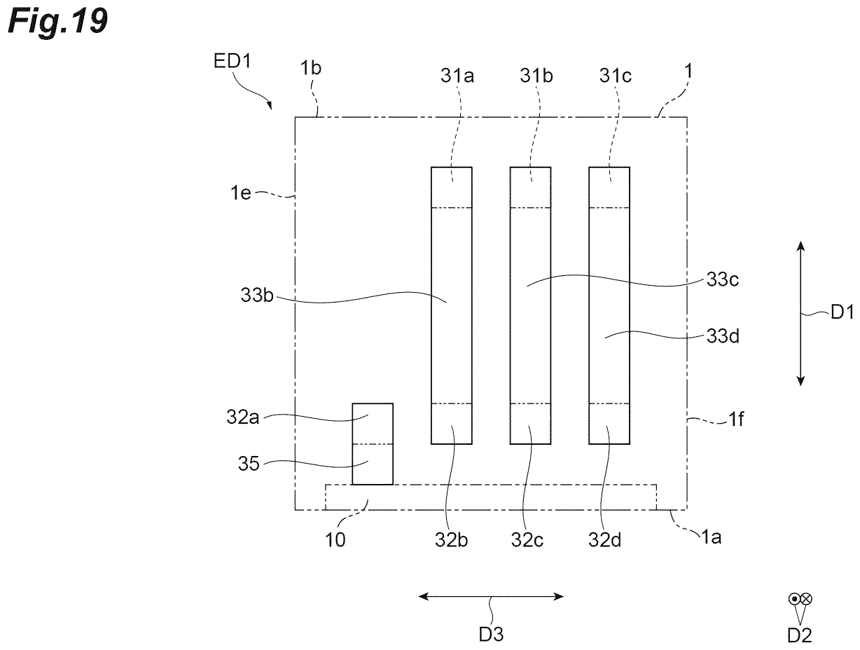

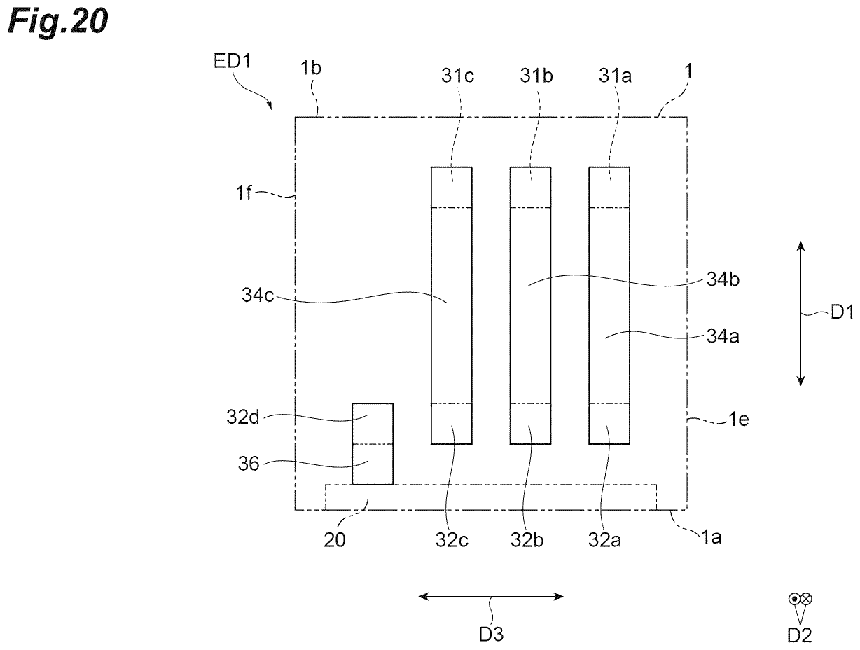

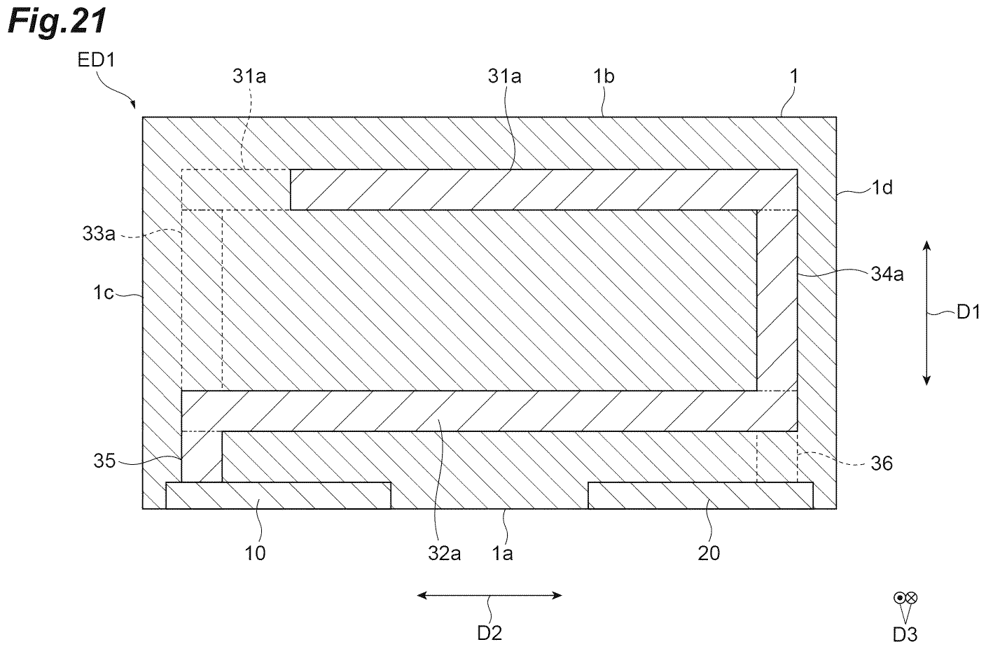

A configuration of a coil component ED1 according to a sixth modified example of the present example will be described with reference to FIGS. 17 to 21. FIG. 17 is a perspective view illustrating a coil component according to the sixth modified example. FIG. 18 is a view illustrating a configuration of a conductor layer. FIGS. 19 and 20 are views illustrating a configuration of the conductor layers and a connection conductor. FIG. 21 is a view illustrating a cross-sectional configuration of the coil component according to the sixth modified example. The coil component ED1 according to the sixth modified example is generally similar to or the same as the coil component ED1 according to the above-described example. However, the coil component ED1 according to the sixth modified example is different from the coil component ED1 according to the above-described example in a configuration of the coil 30. Hereinafter, differences between the above-described example and the sixth modified example will be mainly described.

The conductor layer 31 includes, for example, three conductors 31a, 31b, and 31c. The conductors 31a, 31b and 31c are disposed in the third direction D3. The conductors 31a, 31b, and 31c are disposed substantially parallel to each other. The conductors 31a, 31b and 31c are disposed such that, for example, adjacent conductors of the conductors 31a, 31b, and 31c are substantially equidistant from each other. The conductor portions P1 are positioned closer to the side surface 1c. The conductor portions P2 are positioned closer to the side surface 1d. The conductor portions P1 and P2 extend in the second direction D2.

The conductor portion P1 included in the conductor 31a has a length in the second direction D2 that is smaller than a length in the second direction D2 of the conductor portion P2 included in the conductor 31a. The conductor portion P1 included in the conductor 31b has a same length in the second direction D2 as a length in the second direction D2 of the conductor portion P2 included in the conductor 31b. The conductor portion P1 included in the conductor 31c has a length in the second direction D2 that is larger than a length in the second direction D2 of the conductor portion P2 included in the conductor 31c. The length in the second direction D2 of the conductor portion P1 included in the conductor 31b may be different from the length in the second direction D2 of the conductor portion P2 included in the conductor 31b. The length in the second direction D2 of the conductor portion P1 included in the conductor 31b is larger than the length in the second direction D2 of the conductor portion P1 included in the conductor 31a. The length in the second direction D2 of the conductor portion P1 included in the conductor 31c is larger than the length in the second direction D2 of the conductor portion P1 included in the conductor 31b.

The conductor portion P3 couples the conductor portion P1 and the conductor portion P2. The conductor portion P3 is positioned between the conductor portion P1 and the conductor portion P2 in the second direction D2. The conductor portion P3 extends in a direction different from directions in which the conductor portions P1 and P2 extend. For example, the conductor portion P3 extends substantially in the third direction D3. In the conductors 31a, 31b, and 31c, an angle AG1 between the conductor portion P1 and the conductor portion P3 and an angle AG2 between the conductor portion P2 and the conductor portion P3 are, for example, approximately 90 degrees. The conductor portion P1 is continuous to the conductor portion P3. The conductor portion P3 is continuous to the conductor portion P2.

The conductor layer 32 includes, for example, four conductors 32a, 32b, 32c, and 32d. The conductors 32a, 32b, 32c, and 32d are disposed in the third direction D3. The conductors 32a, 32b, 32c, and 32d are disposed substantially parallel to each other. The conductors 32a, 32b, 32c, and 32d are disposed such that, for example, adjacent conductors of the conductors 32a, 32b, 32c, and 32d are substantially equidistant from each other.

In the conductor 31a, the positions of the conductor portion P1 and the conductor portion P2 in the third direction D3 are different from each other. The conductor portion P1 included in the conductor 31a overlaps with the conductor 32b. The conductor portion P2 included in the conductor 31a overlaps with the conductor 32a. In the conductor 31a, the amount of difference in position between the conductor portion P1 and the conductor portion P2 in the third direction D3 is the same as a distance between the conductor 32a and the conductor 32b in the third direction D3.

In the conductor 31b, the positions of the conductor portion P1 and the conductor portion P2 in the third direction D3 are different from each other. When viewed from the first direction D1, the conductor portion P1 included in the conductor 31b overlaps with the conductor 32c, and the conductor portion P2 included in the conductor 31b overlaps with the conductor 32b. In the conductor 31b, the amount of difference in position between the conductor portion P1 and the conductor portion P2 in the third direction D3 is the same as a distance between the conductor 32b and the conductor 32c in the third direction D3.

In the conductor 31c, the positions of the conductor portion P1 and the conductor portion P2 in the third direction D3 are different from each other. When viewed from the first direction D1, the conductor portion P1 included in the conductor 31c overlaps with the conductor 32d, and the conductor portion P2 included in the conductor 31c overlaps with the conductor 32c. In the conductor 31c, the amount of difference in position between the conductor portion P1 and the conductor portion P2 in the third direction D3 is the same as a distance between the conductor 32c and the conductor 32d in the third direction D3.

A distance between the two adjacent conductors 31a and 31b includes a minimum distance L1 between the conductor portions P1. A distance between the two adjacent conductors 31b and 31c includes the minimum distance L1 between the conductor portions P1. The minimum distance L1 is a minimum distance between the conductor portions P1 in the third direction D3. The distance between the two adjacent conductors 31a and 31b includes a minimum distance L2 between the conductor portions P2. The distance between the two adjacent conductors 31b and 31c includes the minimum distance L2 between the conductor portions P2. The minimum distance L2 is a minimum distance between the conductor portions P2 in the third direction D3. The distance between the two adjacent conductors 31a and 31b includes a minimum distance L3 between the conductor portions P3. The distance between the two adjacent conductors 31b and 31c includes the minimum distance L3 between the conductor portions P3. The minimum distance L3 is a minimum distance between the conductor portions P3 in the second direction D2. The minimum distance L3 is larger than the minimum distance L1 and the minimum distance L2.

As illustrated in FIG. 19, the connection conductor 33 includes a plurality of conductors 33b, 33c, and 33d. The conductor 33b connects the conductor 32b and the conductor 31a. For example, the conductor 33b directly connects the conductor 32b and the conductor 31a. The conductor 33b is continuous with the conductor 32b and continuous with the conductor 31a. The conductor 33c connects the conductor 32c and the conductor 31b. For example, the conductor 33c directly connects the conductor 32c and the conductor 31b. The conductor 33c is continuous with the conductor 32c and continuous with the conductor 31b. The conductor 33d connects the conductor 32d and the conductor 31c. For example, the conductor 33d directly connects the conductor 32d and the conductor 31c. The conductor 33d is continuous with the conductor 32d and continuous with the conductor 31c. The conductor 32a connects the connection conductor 35. For example, the conductor 32a directly connects the connection conductor 35. The conductor 32a is continuous with the connection conductor 35.

As illustrated in FIG. 20, the connection conductor 34 includes a plurality of conductors 34a, 34b, and 34c. The conductor 34a connects the conductor 32a and the conductor 31a. For example, the conductor 34a directly connects the conductor 32a and the conductor 31a. The conductor 34a is continuous with the conductor 32a and continuous with the conductor 31a. The conductor 34b connects the conductor 32b and the conductor 31b. For example, the conductor 34b directly connects the conductor 32b and the conductor 31b. The conductor 34b is continuous with the conductor 32b and continuous with the conductor 31b. The conductor 34c connects the conductor 32c and the conductor 31c. For example, the conductor 34c directly connects the conductor 32c and the conductor 31c. The conductor 34c is continuous with the conductor 32c and continuous with the conductor 31c. The conductor 32d connects the connection conductor 36. For example, the conductor 32d directly connects the connection conductor 36. The conductor 32d is continuous with the connection conductor 36.

As described above, in the coil component ED1, in each of the plurality of conductors 31a, 31b, and 31c, the positions of the conductor portions P1 and P2 in the third direction D3 are different from each other, and the conductor portion P3 extends in the direction different from the directions in which the conductor portion P1 and the conductor portion P2 extend.

The coil component ED1 in which the distance between the adjacent conductors of the conductor 31a, 31b, and 31c is large tends not to cause an electrical short circuit in the coil 30, as compared with a configuration in which the distance between the adjacent conductors of the conductor 31a, 31b, and 31c is small. The coil component ED1 in which the conductor portion P3 extends in the direction different from the directions in which the conductor portion P1 and the conductor portion P2 extend can easily adjust the distance between the conductor portions P3. The coil component ED1 in which the distance between the conductor portions P3 is larger than the distance between the conductor portions P1 can partially increase the distance between the adjacent conductors of the conductor 31a, 31b, and 31c, as compared with a configuration in which the distance between the conductor portions P3 is the same as the distance between the conductor portions P1. The coil component ED1 in which the distance between the conductor portions P3 is larger than the distance between the conductor portions P2 can partially increase the distance between the adjacent conductors of the conductor 31a, 31b, and 31c, as compared with a configuration in which the distance between the conductor portions P3 is the same as the distance between the conductor portions P2.

In the coil component ED1, the distance between the conductor portions P3 is larger than the distance between the conductor portions P1 and larger than the distance between the conductor portions P2. Therefore, the coil component ED1 can reduce occurrence of an electrical short circuit in the coil 30.

In the coil component ED1, the plurality of conductors 31a, 31b, and 31c may include the pair of conductors 31a and 31c and the conductor 31b positioned between the pair of conductors 31a and 31c. The conductor 31b may have the width smaller than the width of each of the pair of conductors 31a and 31c.

A configuration in which the conductor 31b has the width smaller than the width of each of the pair of conductors 31a and 31c can increase the distance between the adjacent conductors of the conductors 31a, 31b, and 31c. Therefore, the coil component ED1 including this configuration can further reduce the occurrence of the electrical short circuit in the coil 30.

In the coil component ED1, the conductor layer 32 may include the conductor 32c including the end connected to the conductor portion P1 included in the conductor 31b and the conductor 32b including the end connected to the conductor portion P2 included in the conductor 31b. The coil 30 may include the connection conductor 33 connecting the conductor portion P1 included in the conductor 31b and the conductor 32c, and the connection conductor 34 for connecting the conductor portion P2 included in the conductor 31b and the conductor 32b. Each of the conductor portion P1 and the conductor 33c may include the end region 33p connected to each other and having the same area. Each of the conductor portion P2 and the conductor 34b may include the end region 34p connected to each other and having the same area.

The coil component ED1 including a configuration in which the coil 30 includes the end regions 33p and 34p can reliably connect the conductor layer 31 and the conductor layer 32 via the end regions 33p and 34p.

In the conductor 31b, the conductor portion P3 may have the width larger than the width of each of the conductor portion P1 and the conductor portion P2.

Inductance of the coil component ED1 is dependent upon the width of the conductor 31b. The coil component ED1 including a configuration in which, in the conductor 31b, the conductor portion P3 has the width larger than the width of each of the conductor portions P1 and P2 can adjust the inductance of the coil component ED1.

In the coil component ED1, each of the plurality of conductors 31a, 31b, and 31c may have the same width throughout the entirety of each of the plurality of conductors 31a, 31b, and 31c.

In the coil component ED1, the angle AG3 and the angle AG4 may be less than 180 degrees.

In the coil component ED1, the angle AG1 and the angle AG2 may be 90 degrees.

The coil component ED1 may include the external electrodes 10 and 20 connected to the coil 30 and disposed on the main surface 1a.

In the present specification, in a case where an element is described as being connected to another element, the element may be directly connected to the other element or be indirectly connected to the other element. In a case where an element is indirectly connected to another element, an intervening element may be present between the element and the other element. In a case where an element is directly connected to another element, no intervening element may be present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

The conductor 31b may not have the width smaller than the width of each of the pair of conductors 31a and 31c.

The configuration in which the conductor 31b has the width smaller than the width of each of the pair of conductors 31a and 31c can increase the distance between the adjacent conductors of the conductor 31a, 31b, and 31c, as described above. Therefore, the coil component ED1 including this configuration can further reduce the occurrence of the electrical short circuit in the coil 30.

The conductor portion P1 and the conductor 33c may not include the end region 33p described above. The conductor portion P2 and the conductor 34b may not include the end region 34p described above. The configuration in which the conductor portion P1 and the conductor 33c include the end region 33p and the conductor portion P2 and the conductor 34b include the end region 34p can reliably connect the conductor layer 31 and the conductor layer 32 via the end regions 33p and 34p, as described above.

In the conductor 31b, the conductor portion P3 may not have the width larger than the width of each of the conductor portion P1 and the conductor portion P2. The configuration in which, in the conductor 31b, the conductor portion P3 has the width larger than the width of each of the conductor portions P1 and P2 can adjust the inductance of the coil component ED1, as described above.

What is claimed is:

1. A coil component comprising:
an element body including a first main surface and a second main surface opposing each other, a first side surface and a second side surface opposing each other, and a third side surface and a fourth side surface opposing each other; and
a coil disposed in the element body, wherein
the coil includes:
a first conductor layer positioned to oppose the first main surface; and
a second conductor layer positioned to oppose the second main surface,
the first conductor layer includes a plurality of first conductors disposed in a direction in which the third side surface and the fourth side surface oppose each other, each of the plurality of first conductors including a first conductor portion positioned closer to the first side surface, a second conductor portion positioned closer to the second side surface and corresponding to the first conductor portion, and a third conductor portion connecting the first conductor portion and the second conductor portion,
the second conductor layer includes a conductor including an end connected to the first conductor portion included in a corresponding first conductor of the plurality of first conductors, and an end connected to the second conductor portion included in the first conductor adjacent to the corresponding first conductor,
in each of the plurality of first conductors, positions of the first conductor portion and the second conductor portion in the direction are different from each other, and the third conductor portion extends in a direction different from directions in which the first conductor portion and the second conductor portion extend, and
in two first conductors adjacent to each other, of the plurality of first conductors, a minimum distance between the third conductor portions is larger than a minimum distance between the first conductor portions and a minimum distance between the second conductor portions.

2. The coil component according to claim 1, wherein
the plurality of first conductors includes a pair of first conductors and at least one first conductor positioned between the pair of first conductors, and
the at least one first conductor has a width smaller than a width of each of the pair of first conductors.

3. The coil component according to claim 2, wherein
the conductor included in the second conductor layer includes:
a fourth conductor including an end connected to the first conductor portion included in the at least one first conductor; and
a fifth conductor including an end connected to the second conductor portion included in the at least one first conductor,
the coil includes:
a first connection conductor connecting the first conductor portion included in the at least one first conductor and the fourth conductor; and
a second connection conductor connecting the second conductor portion included in the at least one first conductor and the fifth conductor,
the first conductor portion and the first connection conductor each include an end region of a same area, the end regions of the first conductor portion and the first connection conductor being connected to each other, and
the second conductor portion and the second connection conductor each include an end region of a same area, the end regions of the second conductor portion and the second connection conductor being connected to each other.

4. The coil component according to claim 2, wherein
in the at least one first conductor, the third conductor portion has a width larger than a width of each of the first conductor portion and the second conductor portion.

5. The coil component according to claim 1, wherein
each of the plurality of first conductors has a same width throughout an entirety of each of the plurality of first conductors.

6. The coil component according to claim 1, wherein
an angle between the first conductor portion and the third conductor portion and an angle between the second conductor portion and the third conductor portion are less than 180 degrees.

7. The coil component according to claim 6, wherein
the angle between the first conductor portion and the third conductor portion and the angle between the second conductor portion and the third conductor portion are 90 degrees.

8. The coil component according to claim 1, further comprising an external electrode connected to the coil and disposed on the first main surface.
